(19) United States
(12) Patent Application Publication
(10) Pub. No.: US 2011/0162490 A1
(43) Pub. Date: Jul. 7, 2011

(54) Handle Assembly for Hex Wrench

(76) Inventor: Maan-Jyi Chang, Taichung Hsien (TW)

(21) Appl. No.: 12/652,257

(22) Filed: Jan. 5, 2010

(51) Int. Cl. B25B 23/16; B25B 29/00

(52) U.S. Cl. 81/177.1; 81/184

(57) ABSTRACT

A handle assembly for a hex wrench includes a handle body and a holding member rotatably mounted on the handle body. The handle body has a first end provided with a limit flange to limit the holding member and a second end provided with at least one cutout which is formed with at least one flexible clamping portion. The handle body has a mediate portion provided with a mounting groove for mounting the holding member. The head or handle of a hex wrench is inserted into the handle body and is clamped by the clamping portion. Thus, the handle body is rotatable relative to the holding member so that the user can hold the holding member to drive the head or handle of the hex wrench so as to operate the hex wrench easily and quickly.

### BACKGROUND OF THE INVENTION

1. Field of the Invention

The present invention relates to a handle assembly and, more particularly, to a handle assembly for a hex wrench.

2. Description of the Related Art

A conventional hex wrench is used to screw or unscrew a hex hole screw. The conventional hex wrench comprises a handle and a head. When in use, the handle or head of the hex wrench is inserted into the hex hole screw to rotate the hex hole screw so as to tighten or loosen the hex hole screw. However, the handle or head of the hex wrench has a hexagonal shape so that when the user holds the handle or head of the hex wrench, the angled corners of the handle or head of the hex wrench will press the user's hand, thereby easily causing an uncomfortable sensation to the user. In addition, the head of the hex wrench has a length much smaller than that of the handle of the hex wrench so that the head of the hex wrench cannot be used to rotate the handle of the hex wrench easily and quickly, thereby causing inconvenience to the user.

### BRIEF SUMMARY OF THE INVENTION

In accordance with the present invention, there is provided a handle assembly for a hex wrench, comprising a handle body and a holding member rotatably mounted on the handle body. The handle body has an inner portion provided with a mounting hole. The handle body has a first end provided with a limit flange to limit the holding member and a second end provided with at least one cutout which is formed with at least one flexible clamping portion. The handle body has a mediate portion provided with a mounting groove for mounting the holding member.

The primary objective of the present invention is to provide a handle assembly that facilitates a user operating a hex wrench.

According to the primary objective of the present invention, the handle body is rotatable relative to the holding member so that the handle or the head of the hex wrench and the handle body can be rotated relative to the holding member, and the user can easily hold the holding member of the handle assembly to drive the head or handle of the hex wrench so as to operate the hex wrench easily and quickly.

According to another objective of the present invention, the clamping portion of the handle body can be used to clamp the handle or the head of the hex wrench so that the handle assembly is available for multiple hex wrenches of similar sizes, thereby decreasing the cost of fabrication.

According to a further objective of the present invention, the handle assembly co-operates with the hex wrench to function as a T-shaped handle or an L-shaped handle, thereby enhancing the versatility of the handle assembly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a handle assembly in accordance with the preferred embodiment of the present invention.

FIG. 2 is an exploded perspective view of the handle assembly as shown in FIG. 1.

FIG. 3 is a front cross-sectional view of the handle assembly as shown in FIG. 1.

FIG. 4 is a perspective view of the handle assembly for a hex wrench in accordance with the preferred embodiment of the present invention.

FIG. 5 is a front cross-sectional view of the handle assembly for a hex wrench as shown in FIG. 4.

FIG. 6 is a front cross-sectional view of the handle assembly for a hex wrench in accordance with the preferred embodiment of the present invention.

FIG. 7 is a front cross-sectional view of the handle assembly for a hex wrench in accordance with the preferred embodiment of the present invention.

FIG. 8 is a perspective view of a handle assembly in accordance with another preferred embodiment of the present invention.

FIG. 9 is an exploded perspective view of the handle assembly as shown in FIG. 8.

FIG. 10 is a perspective view showing combination of a plurality of handle assemblies as shown in FIG. 8.

### DETAILED DESCRIPTION OF THE INVENTION

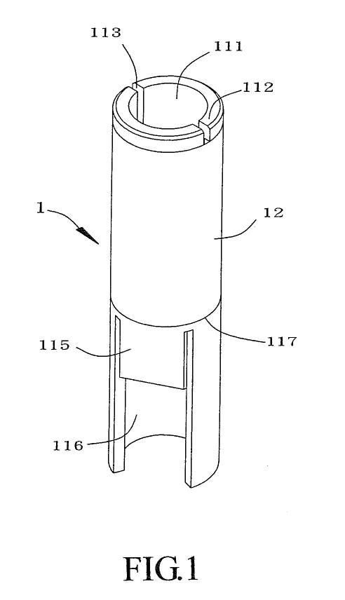

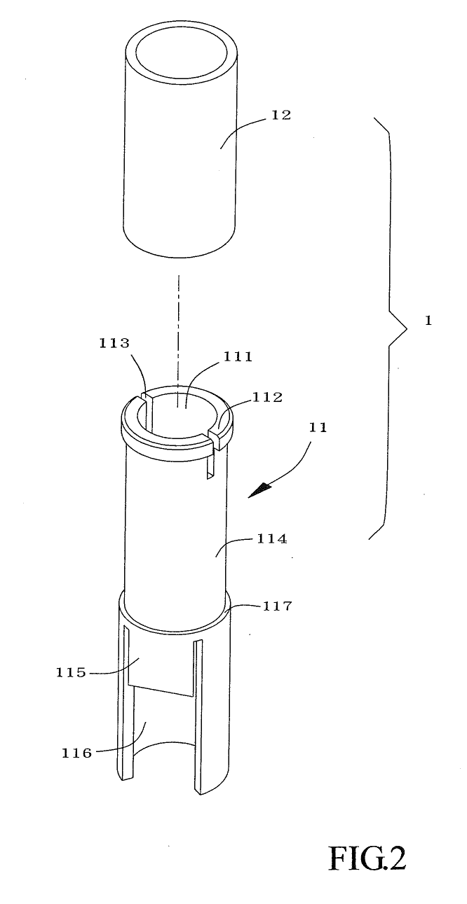

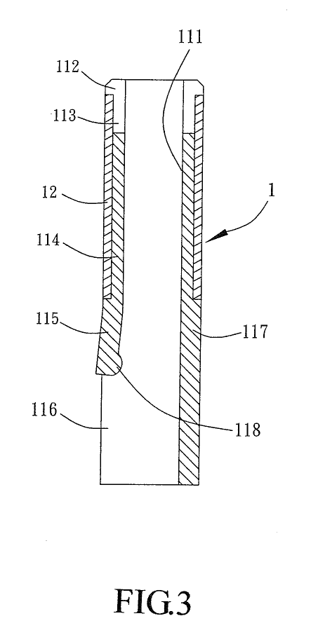

Referring to the drawings and initially to FIGS. 1-3, a handle assembly 1 for a hex wrench in accordance with the preferred embodiment of the present invention comprises a handle body 11 and a holding member 12 rotatably mounted on the handle body 11.

The handle body 11 has an inner portion provided with a mounting hole 111. The mounting hole 111 of the handle body 11 extends through a whole length of the handle body 11. The handle body 11 has a first end provided with a limit flange 112 to limit the holding member 12 and a second end provided with at least one cutout 116 which is formed with at least one flexible clamping portion 115. The limit flange 112 of the handle body 11 has an annular shape and extends radially and outwardly from the handle body 11. The limit flange 112 of the handle body 11 has a periphery provided with at least one slit 113 so that the limit flange 112 of the handle body 11 is made flexible by the at least one slit 113. The at least one slit 113 of the limit flange 112 is connected to the mounting hole 111 of the handle body 11.

The cutout 116 of the handle body 11 is connected to the mounting hole 111 of the handle body 11 and has a length greater than that of the clamping portion 115. The clamping portion 115 of the handle body 11 is inclined toward the mounting hole 111 of the handle body 11. The clamping portion 115 of the handle body 11 has a distal end provided with an enlarged pressing boss 118 which extends into the mounting hole 111 of the handle body 11.

The second end of the handle body 11 is provided with a stop flange 117 to stop the holding member 12. The handle body 11 has a mediate portion provided with a mounting groove 114 for mounting the holding member 12. The mounting groove 114 of the handle body 11 is located between the limit flange 112 and the stop flange 117 and is connected to the at least one slit 113. The mounting groove 114 of the handle body 11 has a diameter smaller than that of the limit flange 112 and that of the stop flange 117.

The holding member 12 is rotatably mounted in the mounting groove 114 of the handle body 11 and is limited between the limit flange 112 and the stop flange 117 of the handle body 11. In the preferred embodiment of the present invention, each of the handle body 11, the mounting groove 114 of the handle body 11 and the holding member 12 has a substantially cylindrical cross-sectional profile.

In assembly, when the holding member 12 is mounted on the limit flange 112 of the handle body 11, the limit flange 112 of the handle body 11 is contracted inwardly by the at least one slit 113 to allow passage of the holding member 12 so that the holding member 12 can be extended into and received in the mounting groove 114 of the handle body 11. After the holding member 12 is received in the mounting groove 114 of the handle body 11, the limit flange 112 of the handle body 11 is expanded outwardly by its resilience so that the holding member 12 is limited between the limit flange 112 and the stop flange 117 of the handle body 11. In such a manner, the holding member 12 is rotatably mounted in the mounting groove 114 of the handle body 11 so that the handle body 11 is rotatable relative to the holding member 12.

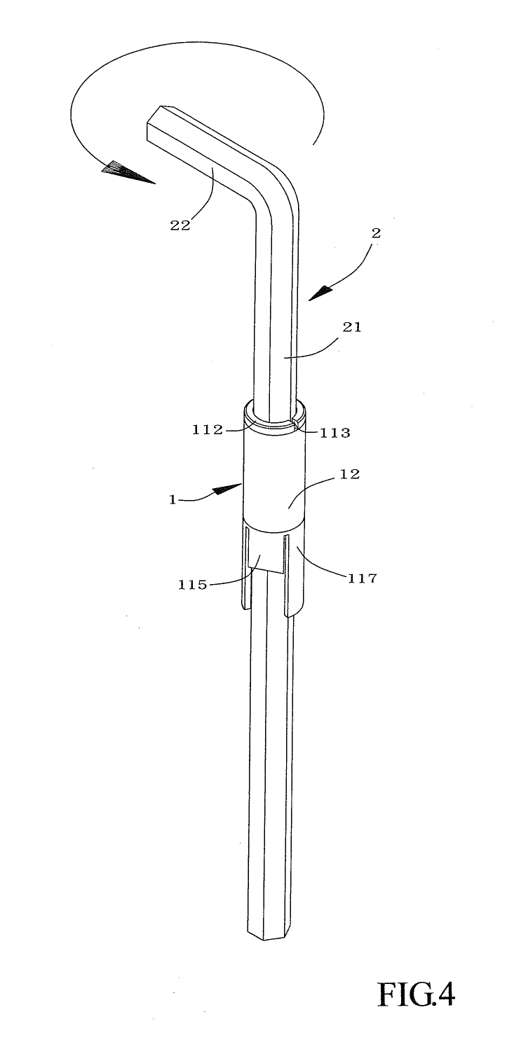

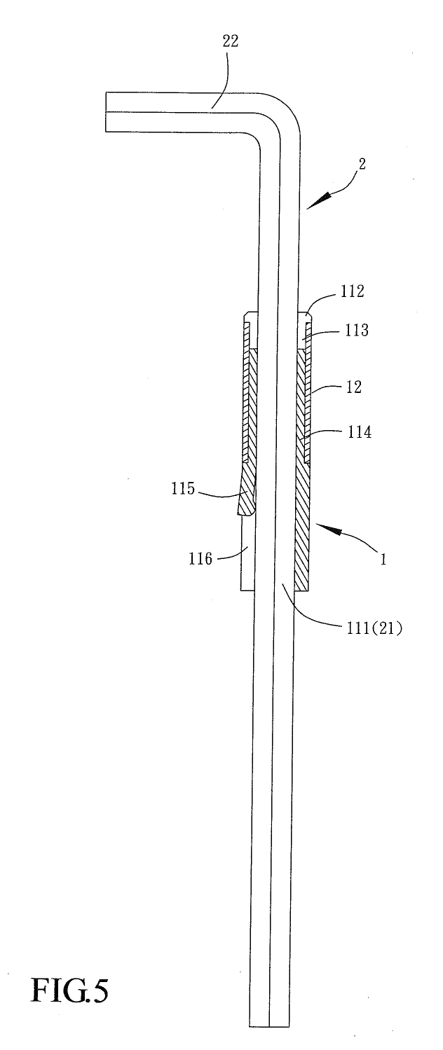

In operation, referring to FIGS. 4 and 5 with reference to FIGS. 1-3, the handle assembly 1 can co-operate with a hex wrench 2 which has a handle 21 and a head 22. In assembly, the handle 21 of the hex wrench 2 is inserted through the limit flange 112 into the mounting hole 111 of the handle body 11 and is clamped by the clamping portion 115 of the handle body 11. When in use, the handle 21 of the hex wrench 2 is inserted into a hex hole screw (not shown). Then, the holding member 12 is held by a user, and the head 22 of the hex wrench 2 is turned around to rotate the handle 21 of the hex wrench 2 so as to rotate the hex hole screw. At this time, the handle body 11 is rotatable relative to the holding member 12 so that the handle 21 of the hex wrench 2 and the handle body 11 can be rotated relative to the holding member 12. In such a manner, the user's one hand can hold the holding member 12 of the handle assembly 1, and the user's other hand can hold the head 22 of the hex wrench 2 to rotate the handle 21 of the hex wrench 2 and the handle body 11 relative to the holding member 12 so as to rotate the hex hole screw easily and quickly.

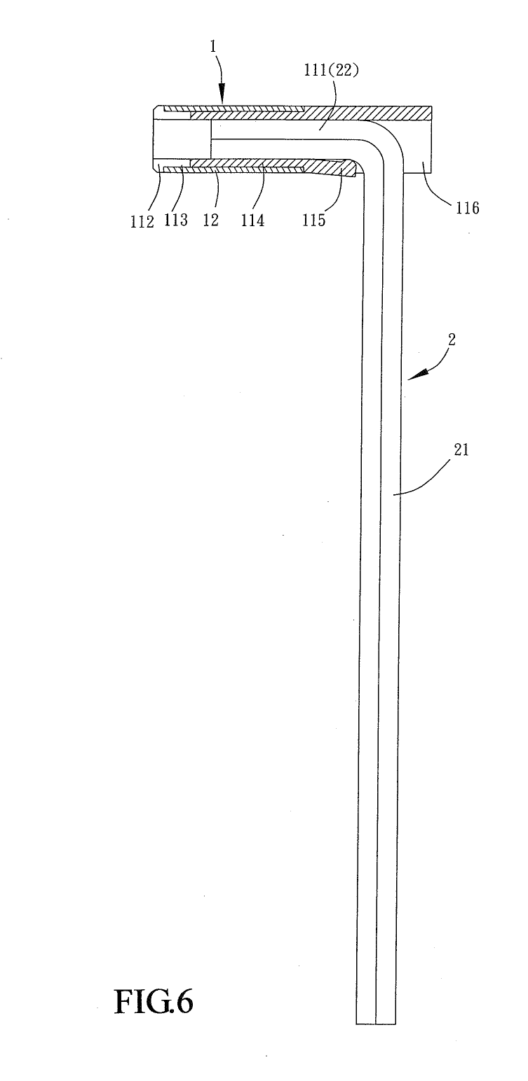

Alternatively, referring to FIG. 6, the head 22 of the hex wrench 2 is inserted through the cutout 116 into the mounting hole 111 of the handle body 11 and is clamped by the clamping portion 115 of the handle body 11. When in use, the handle 21 of the hex wrench 2 is inserted into a hex hole screw (not shown). Then, the holding member 12 of the handle assembly 1 is turned by a user so that the head 22 of the hex wrench 2 is turned by the holding member 12 of the handle assembly 1 to rotate the handle 21 of the hex wrench 2 so as to rotate the hex hole screw. Thus, the handle assembly 1 co-operates with the hex wrench 2 to function as a T-shaped handle.

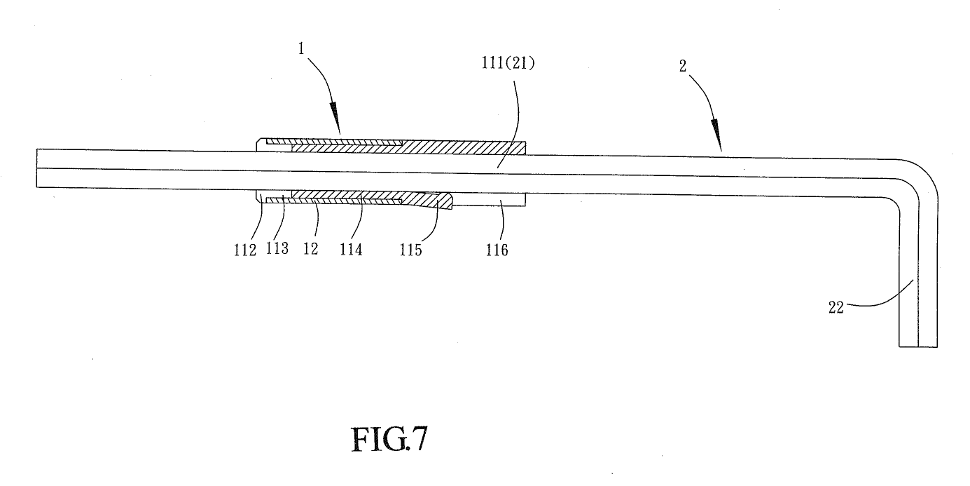

Alternatively, referring to FIG. 7, the handle 21 of the hex wrench 2 is inserted through the cutout 116 into the mounting hole 111 of the handle body 11 and is clamped by the clamping portion 115 of the handle body 11. When in use, the head 22 of the hex wrench 2 is inserted into a hex hole screw (not shown). Then, the holding member 12 of the handle assembly 1 is turned by a user so that the handle 21 of the hex wrench 2 is turned by the holding member 12 of the handle assembly 1 to rotate the head 22 of the hex wrench 2 so as to rotate the hex hole screw. Thus, the handle assembly 1 co-operates with the hex wrench 2 to function as an L-shaped handle.

Accordingly, the handle body 11 is rotatable relative to the holding member 12 so that the handle 21 or the head 22 of the hex wrench 2 and the handle body 11 can be rotated relative to the holding member 12, and the user can easily hold the holding member 12 of the handle assembly 1 to drive the handle 21 or the head 22 of the hex wrench 2 so as to operate the hex wrench 2 easily and quickly. In addition, the clamping portion 115 of the handle body 11 can be used to clamp the handle 21 or the head 22 of the hex wrench 2 so that the handle assembly 1 is available for multiple hex wrenches 2 of similar sizes, thereby decreasing the cost of fabrication. Further, the handle assembly 1 co-operates with the hex wrench 2 to function as a T-shaped handle or an L-shaped handle, thereby enhancing the versatility of the handle assembly 1.

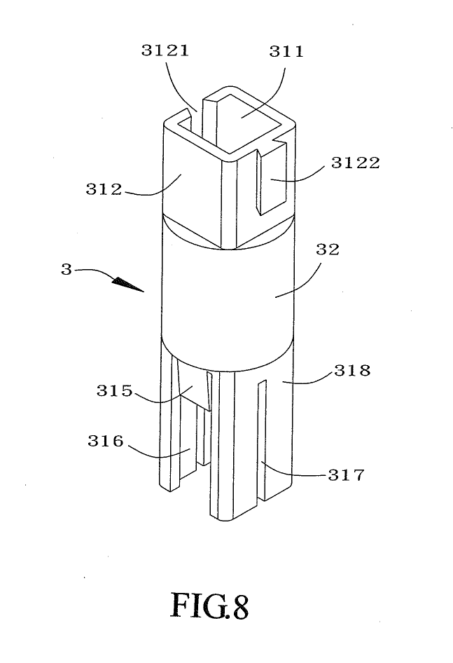

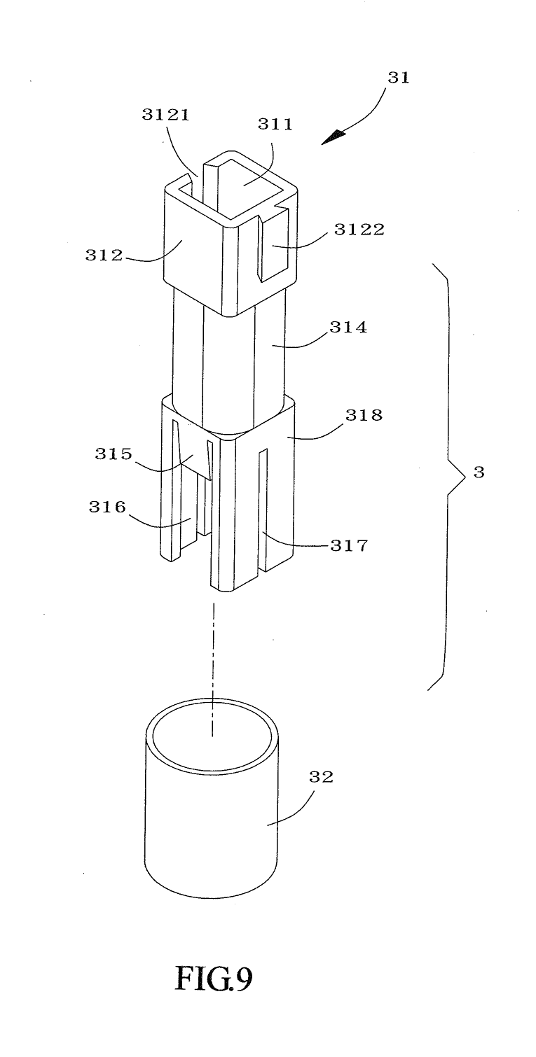

Referring to FIGS. 8 and 9, a handle assembly 3 for a hex wrench in accordance with another preferred embodiment of the present invention comprises a handle body 31 and a holding member 32 mounted on the handle body 31. The handle body 31 has an inner portion provided with a mounting hole 311. The mounting hole 311 of the handle body 31 extends through a whole length of the handle body 31.

The handle body 31 has a first end provided with a limit flange 312 to limit the holding member 32 and a second end provided with at least one cutout 316 which is formed with at least one flexible clamping portion 315. The limit flange 312 of the handle body 31 has a first side provided with a locking block 3122 and a second side provided with a locking slot 3121. The clamping portion 315 of the handle body 31 is inclined toward the mounting hole 311 of the handle body 31. The second end of the handle body 31 is provided with a stop flange 318 to stop the holding member 32. The handle body 31 has a mediate portion provided with a mounting groove 314 for mounting the holding member 32. The mounting groove 314 of the handle body 31 is located between the limit flange 312 and the stop flange 318. The mounting groove 314 of the handle body 31 has a size smaller than that of the limit flange 312 and that of the stop flange 318.

The holding member 32 is rotatably mounted in the mounting groove 314 of the handle body 31 and is limited between the limit flange 312 and the stop flange 318 of the handle body 31. In the preferred embodiment of the present invention, each of the mounting groove 314 of the handle body 31 and the holding member 32 has a substantially cylindrical cross-sectional profile.

The stop flange 318 of the handle body 31 has a periphery provided with at least one slit 317 so that the stop flange 318 of the handle body 31 is made flexible by the at least one slit 317. The at least one slit 317 of the stop flange 318 is connected to the mounting hole 311 of the handle body 31.

In assembly, when the holding member 32 is mounted on the stop flange 318 of the handle body 31, the stop flange 318 of the handle body 31 is contracted inwardly by the at least one slit 317 to allow passage of the holding member 32 so that the holding member 32 can be extended into and received in the mounting groove 314 of the handle body 31. After the holding member 32 is received in the mounting groove 314 of the handle body 31, the stop flange 318 of the handle body 31 is expanded outwardly by its resilience so that the holding member 32 is limited between the limit flange 312 and the stop flange 318 of the handle body 31. In such a manner, the holding member 32 is rotatably mounted in the mounting groove 314 of the handle body 31 so that the handle body 31 is rotatable relative to the holding member 32.

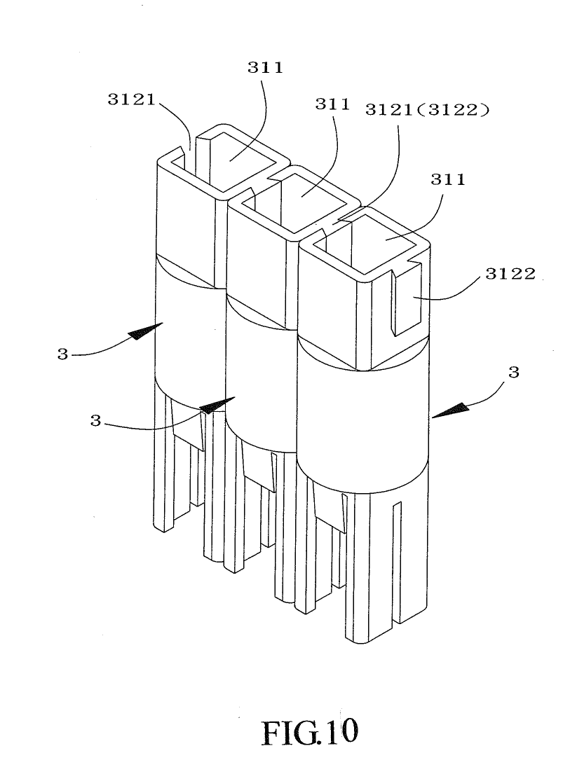

Referring to FIG. 10, when a plurality of handle assemblies 3 are combined, the locking block 3122 of one of the handle assemblies 3 is inserted into and locked in the locking slot 3121 of another one of the handle assemblies 3 so that the handle assemblies 3 are combined together by engagement between the locking block 3122 and the locking slot 3121.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A handle assembly for a hex wrench, comprising:
a handle body;
a holding member rotatably mounted on the handle body;
wherein the handle body has an inner portion provided with a mounting hole;
the handle body has a first end provided with a limit flange to limit the holding member and a second end provided with at least one cutout which is formed with at least one flexible clamping portion;
the handle body has a mediate portion provided with a mounting groove for mounting the holding member.

2. The handle assembly for a hex wrench of claim 1, wherein the limit flange of the handle body has a periphery provided with at least one slit so that the limit flange of the handle body is made flexible by the at least one slit.

3. The handle assembly for a hex wrench of claim 1, wherein the clamping portion of the handle body is inclined toward the mounting hole of the handle body.

4. The handle assembly for a hex wrench of claim 1, wherein the mounting groove of the handle body has a diameter smaller than that of the limit flange.

5. The handle assembly for a hex wrench of claim 1, wherein the holding member is rotatably mounted in the mounting groove of the handle body.

6. The handle assembly for a hex wrench of claim 1, wherein the limit flange of the handle body has a first side provided with a locking block and a second side provided with a locking slot.

7. The handle assembly for a hex wrench of claim 1, wherein the second end of the handle body is provided with a stop flange to stop the holding member.

8. The handle assembly for a hex wrench of claim 7, wherein the stop flange of the handle body has a periphery provided with at least one slit so that the stop flange of the handle body is made flexible by the at least one slit.

9. The handle assembly for a hex wrench of claim 8, wherein the at least one slit of the stop flange is connected to the mounting hole of the handle body.

10. The handle assembly for a hex wrench of claim 7, wherein the mounting groove of the handle body is located between the limit flange and the stop flange.

11. The handle assembly for a hex wrench of claim 5, wherein
the mounting groove of the handle body has a substantially cylindrical cross-sectional profile;
the holding member has a substantially cylindrical cross-sectional profile.

12. The handle assembly for a hex wrench of claim 10, wherein the holding member is limited between the limit flange and the stop flange of the handle body.

13. The handle assembly for a hex wrench of claim 2, wherein the at least one slit of the limit flange is connected to the mounting hole of the handle body.

14. The handle assembly for a hex wrench of claim 3, wherein the clamping portion of the handle body has a distal end provided with an enlarged pressing boss which extends into the mounting hole of the handle body.

15. The handle assembly for a hex wrench of claim 7, wherein the mounting groove of the handle body has a diameter smaller than that of the stop flange.

16. The handle assembly for a hex wrench of claim 2, wherein the mounting groove of the handle body is connected to the at least one slit.

17. The handle assembly for a hex wrench of claim 1, wherein the mounting hole of the handle body extends through a whole length of the handle body.

18. The handle assembly for a hex wrench of claim 1, wherein
the cutout of the handle body is connected to the mounting hole of the handle body;
the cutout of the handle body has a length greater than that of the clamping portion.

19. The handle assembly for a hex wrench of claim 1, wherein the limit flange of the handle body has an annular shape and extends radially and outwardly from the handle body.

20. The handle assembly for a hex wrench of claim 6, wherein when a plurality of handle assemblies are combined, the locking block of one of the handle assemblies is inserted into and locked in the locking slot of another one of the handle assemblies so that the handle assemblies are combined together by engagement between the locking block and the locking slot.
